(19) United States
(12) Patent Application Publication
(10) Pub. No.: US 2005/0270633 A1
(43) Pub. Date: Dec. 8, 2005

(54) Photonic crystal mirrors for high-resolving power fabry perots

(76) Inventors: Peter Herman, Mississauga (CA); Jianzhao Li, Toronto (CA); Vladimir Kitaev, Toronto (CA)

Correspondence Address: Ralph A. Dowell of DOWELL & DOWELL P.C., 2111 Eisenhower Ave., Suite 406, Alexandria, VA, 22314, US

(21) Appl. No.: 11/129,650

(22) Filed: May 16, 2005

Related U.S. Application Data
(60) Provisional application No. 60/570,902, filed on May 14, 2004.

(51) Int. Cl. G02F 1/00; G02B 26/00

(52) U.S. Cl. 359/321

(57) ABSTRACT

A Fabry-Perot cavity comprised of three-dimensional photonic crystal structures is disclosed. The self-assembly of purified and highly monodispersed microspheres is one approach to the successful operation of the device for creating highly ordered colloidal crystal coatings of high structural and optical quality. Such colloidal crystal film mirrors offer high reflection with low losses in the spectral window of the photonic band gap that permit Fabry-Perot resonators to be constructed with high resolving power, for example, greater than 1000 or sharp fringes that are spectrally narrower than 1.0 nm. The three-dimensional photonic crystals that constitute the Fabry-Perot invention are not restricted to any one fabrication method, and may include self-assembly of colloids, layer-by-layer lithographic construction, inversion, and laser holography. Such photonic crystal Fabry-Perot resonators offer the same benefits of high reflection and narrow spectral band responses available from the use of multi-layer dielectric coatings. However, the open structure of three-dimensional photonic crystal films affords the unique ability for external media to access the critical reflection layers and dramatically alter the Fabry-Perot spectrum, and provide means for crafting novel laser, sensor, and nonlinear optical devices. This open structure enables the penetration of gas and liquid substances, or entrainment of nano-particles or biological analytes in gases and liquids, to create subtle changes to the colloidal mirror responses that manifest in strong spectral responses in reflection and transmission of the collective Fabry Perot response.

### CROSS REFERENCE TO RELATED U.S APPLICATION

This patent application relates to, and claims the priority benefit from, U.S. Provisional Patent Application Ser. No. 60/570,902 filed on May 14, 2004, which is incorporated herein by reference in its entirety.

### FIELD OF THE INVENTION

The present invention relates to three dimensional photonic crystal mirrors for Fabry-Perot resonators.

### BACKGROUND OF THE INVENTION

Inhibition of electromagnetic wave propagation within a particular frequency range (photonic band gap or stop band) inside photonic crystals has enabled the application of photonic crystals as highly reflective mirrors. Fabry-Perot type resonant cavities have been fabricated employing one dimensional [T. F. Krauss, B. Vögele, C. R. Stanley, and R. M. De La Rue, IEEE Photonics Technol. Lett. 9, 176 (1997)] and two dimensional [S.-Y. Lin, V. M. Hietala, S. K. Lyo, and A. Zaslavsky, Appl. Phys. Lett. 68, 3233 (1996)] photonic crystal mirrors, and are pervasive in the one-dimensional case with the use of multi-layered dielectric mirrors. In all cases of two-dimensional photonic crystal Fabry-Perot devices, the two-dimensional period structure was formed by parallel arrangement of dielectric rods with millimeter to centimeter lattice constants, or by multi-step fabrication processes with electron beam lithography and reactive ion etching of semiconductor materials.

Microsphere self-assembly is a suitable approach for making colloidal photonic crystals, and several embodiments for their use have been proposed. [R. Rengarajan, T. Prasad, V. L. Colvin, D. M. Mittleman, Proceedings of SPIE-The International Society for Optical Engineering 4809, 17 (2002); P. Landon, R. Glosser, A. Zakhidov, Trends in Optics and Photonics 91, 52 (2003); R. Anselmann, H. Winkler, Adv. Eng. Mater. 5, 560 (2003); Lin, Shawn-Yu et al., Optical elements comprising photonic crystals and applications thereof, U.S. Patent 2001/0012149]. Generally, this approach is considered less controllable and technically more challenging to exploit because of the precision necessary to create uniformly periodic structures in all three dimensions.

Similarly, other three-dimensional photonic crystal fabrication methods (i.e. holographic interference in a resist, laser photopolymerization, Lincoln logs) have been equally difficult to optimize for low optical losses and high reflectivity. For this reason, fine-pitch Fabry-Perot resonances inside the stop band have not been previously reported because of scattering and other losses that prevent the build up of sufficiently strong resonant reflections. However, Fabry Perot resonances have been observed outside the stop band which arises from weak resonances due to small Fresnel reflections at the various interfaces between the colloid film, substrate, and air. Such out-of-band fringes are frequently observable from single layer colloidal films grown on transparent substrates. Further, Lin et al. [United States Patent Publication U.S.2001/0012149 A1] discloses multiple reflections for frequencies outside the photonic band gap of two photonic crystal mirrors that are physically separated to form a Fabry Perot resonator.

The relatively poor optical quality of most three-dimensional photonic crystals produced to date has precluded the practical observation of sharp Fabry-Perot resonances in the stop band. The only exception for three-dimensional photonic crystals is the observation of a weak and broad ‘defect’ resonance appearing as a single transmission resonance inside the otherwise low-transmittance stop band. To form this defect resonance, a thin modification or growth zone (approximately 1 μm thick) is formed as a planar layer inside the three-dimensional photonic crystals such that the optical periodicity of the two outside crystals is shifted by a small distance on size scale similar to the periodicity of the crystal lattice. This central layer introduces a phase shift that theoretically forms a sharp defect in the stop ban. Wostyn et al. [K. Wostyn, Y. Zhao, G. de Schaetzen, L. Hellemans, N. Matsuda, K. Clays, and A. Persoons, Langmuir 19, 4465 (2003)] grew three layers of colloidal films, such that the thin centre colloidal layer of larger spheres was sandwiched by two thick colloidal layers grown from identical spheres with diameter smaller than the central layer. Only one weak and broad defect line was observed inside the stop band in the visible spectrum. Alternatively, Ozbay et al. [E. Ozbay, G. Tuttle, M. Sigalas, C. M. Soukoulis, K. M. Ho, Defect structures in layer-by-layer photonic band-gap crystal, Phys. Rev. B, 51, 13961-13965 (1995)] added or removed dielectric material of selected rods in a layer-by-layer structure to form a single resonant defect in the microwave spectrum.

U.S. Pat. No. 6,433,931 B1 issued to Fink et al. further discloses that planar defect can be created by inserting into a polymeric photonic band gap structure a plane of material different from the materials defining the polymeric structure.

Kopp et al. in U.S. Pat. Nos. 6,396,859 and 6,396,859] notes that such a planar defect can be created by rotating one chiral structure photonic crystal relative to another along a common longitudinal axis. In a related patent, Kopp et al. in U.S. Pat. No. 6,404,789 further discloses a sandwich structure of a laser active material between two chiral photonic crystals can be used to create a single defect.

At the time of first filing of the present invention (May 14, 2004), published demonstrations and claims did not go beyond the formation of more than one single defect spectral line within the stop band of three-dimensional photonic crystals. In this regard, only minor modifications to the structure were considered, and comprising largely of forming thin modification planes of approximately optical wavelength (˜1-μm) thickness into the centre of the photonic crystal. The formation of two or more transmission resonance lines inside the photonic bandgap by means of Fabry Perot resonators or etalons with separations beyond an optical wavelength was not considered for the three-dimensional photonic crystal.

Recently, Ozin and coworkers [S. Wong, V. Kitaev, and G. A. Ozin, J. Amer. Chem. Soc. 125, 15589 (2003)] demonstrated that very high quality colloidal crystal film can be produced, by using purified highly monodisperse microspheres under tightly controlled deposition conditions. In one embodiment of the present invention, self-assembly colloidal crystal chemistry is applied to produce practically efficient, high-Q and high resolving-power Fabry-Perot resonant cavities. Reduction of microsphere size dispersity and a consequent increase of colloidal photonic crystal quality towards that of large domain single domains, were key to producing such high optical quality devices.

### SUMMARY OF THE INVENTION

The present invention provides a device for multireflection of electromagnetic waves comprising,
a substantially transparent substrate having first and second opposed planar or curved surfaces spaced by a pre-selected thickness;
a first three dimensional photonic crystal film deposited on said first opposed surface having a first stop band, and a second three dimensional photonic crystal film deposited on said second opposed surface having said stop band, the first and second three dimensional photonic crystal films having a second stop band in a pre-selected spectral region; and
wherein illuminating said device with a light beam of pre-selected wavelength results in interference fringes located within at least one of the first and second stop bands.

The present invention also provides device for multireflection of electromagnetic waves comprising,
a substantially transparent substrate having first and second opposed planar or curved surfaces spaced by a pre-selected thickness;
a three dimensional photonic crystal film deposited on said first opposed surface having a stop band in a pre-selected spectral region, and a reflective coating deposited on said second opposed surface; and
wherein illuminating said device with a light beam of pre-selected wavelength results in interference fringes located within the stop band of the three dimensional photonic crystal film on first opposed surface.

In another aspect of the invention there is provided a evice for multireflection of electromagnetic waves comprising,
a first substantially transparent substrate having a first planar or curved surface;
a second substantially transparent or opaque substrate having a second planar or curved surface substantially “parallel” to, and separated from said first surface a pre-selected distance to support an optical resonator;
a first three dimensional photonic crystal film deposited on said first surface having a first stop band in a first spectral region, and a second three dimensional photonic crystal film deposited on said second surface having a second stop band in a second spectral region;
wherein illuminating said device with a light beam of pre-selected wavelength results in interference fringes located within at least one of the first and second stop bands.

The present invention also provides a device for multireflection of electromagnetic waves comprising,
a first substantially transparent substrate having a first planar or curved surface;
a second substantially transparent or opaque substrate having a second planar or curved surface substantially “parallel” to, and separated from said first surface a pre-selected distance to support an optical resonator;
a three dimensional photonic crystal film deposited on said first surface having a stop band in a spectral region, and a reflective coating deposited on said second opposed surface; and
wherein illuminating said device with a light beam of pre-selected wavelength results in interference fringes located within the stop band.

The present invention provides a device for multireflection of electromagnetic waves comprising a combination of one or more films comprised of three-dimensional photonic crystals, in geometric arrangement to provide multireflection of electromagnetic waves.

In this aspect of the invention the three-dimensional photonic crystals have photonic band gaps (or stop bands), wherein optical signals within a working optical spectrum are excluded from the photonic crystal by photonic band gaps.

In another aspect of the present invention there is provided a device for multireflection of electromagnetic waves, comprising:
one of an optically transparent or partially transparent substrate, said substrate having first and second planar, parallel or optically curved faces and a layer of mono-dispersed silica microspheres in the form of a colloidal photonic crystal located on each of the first and second faces with the two layers being of substantially the same thickness.

In another aspect of the present invention there is provided a device for multireflection of electromagnetic waves, comprising:
two of optically transparent or partially transparent substrates, said substrate having first and second planar, parallel or optically curved faces and a layer of mono-dispersed silica microspheres in the form of a colloidal photonic crystal located on each of the first and second faces with the two layers being of substantially the same thickness.

These and various permutations of the disclosed invention are described in in sections below.

### BRIEF DESCRIPTION OF THE DRAWINGS

The colloidal photonic crystal mirrors for high-resolving-power Fabry-Perot resonators produced according to the present invention will now be described, by way of example only, reference being made to the accompanying drawings, in which:

FIG. 1a shows a schematic diagram of a first embodiment of a photonic crystal etalon formed using two similar colloidal photonic crystal coatings (or any type of three-dimensional photonic crystal) on opposite surfaces of a transparent or partially transparent substrate;

FIG. 1b shows a schematic diagram of a second embodiment of a photonic crystal etalon formed using one colloidal photonic crystal coating (or any type of three-dimensional photonic crystal) on one side of a transparent or partially transparent substrate and a coating, such as a dielectric mirror, metal, Fresnel reflector, partial mirror on the other side of the transparent substrate to form a resonator;

FIG. 2a shows an embodiment of a Fabry-Perot cavity formed using two three-dimensional photonic crystal mirrors with tunable cavity length deposited on two transparent or semi-transparent substrates aligned so the photonic crystal mirrors are facing each other;

FIG. 2b shows another embodiment of a Fabry-Perot cavity formed using one three-dimensional photonic crystal mirror deposited on a transparent or semi-transparent substrate and a mirror, such as multilayered dielectric mirror, metal film, Fresnel reflector, or partial mirror on another substrate, the cavity having a tunable cavity length with the substrates aligned so the photonic crystal mirror and the other coating are facing each other;

FIG. 3a shows a photographic image of a silica colloidal photonic crystal mirror comprising the Fabry-Perot etalon;

FIG. 3b shows a scanning electron microscope image of the planar colloidal photonic crystal (111) surface of the device of FIG. 3a;

FIG. 3c shows a scanning electron microscope image of a cylindrically curved colloidal mirror;

FIG. 4 shows a fiber optical arrangement for probing the transmission spectrum of the colloidal photonic crystal Fabry Perot;

FIG. 5a shows a normalized transmission spectrum of a Fabry-Perot etalon coated with silica colloidal photonic crystal mirrors (lower spectrum) and comparison with normalized transmission of the ˜150-μm thick glass substrate (upper spectrum), with an enlargement of the Fabry Perot spectrum in the photonic band gap region ishown in the inset figure;

FIG. 5b shows the cavity quality factor plotted as a function of wavelength in the photonic band gap region;

FIG. 6 shows a 1D simulation of a normalized transmission spectrum of a Fabry-Perot cavity coated with silica colloidal photonic crystal mirrors, the inset shows the spectrum enlarged in the photonic band gap center together with the measured result (dashed line) from FIG. 5;

FIG. 7a shows the normalized transmission spectrum of a SiO₂ colloidal photonic crystal Fabry-Perot etalon for TM for polarization at 0° and 300 angle of incidence;

FIG. 7b shows the normalized transmission spectrum of a SiO₂ colloidal photonic crystal Fabry-Perot etalon for TE polarization at 0° and 30° angle of incidence;

FIG. 8a shows the normalized transmission spectrum of a SiO₂ colloidal photonic crystal Fabry-Perot etalon measured at 30° incident angle with linear polarization orientations of 0, 45, 60, 70, and 90 degrees as illustrated;

FIG. 8b is a plot of the peak transmission wavelength (for the same interference order of fringe) as a function of the linear polarization orientation angle;

FIGS. 9a to 9c show transmission spectra of a tunable photonic crystal Fabry Perot with cavity lengths of ˜14 μm shown in FIG. 9a, ˜35 μm shown in FIG. 9b and ˜200 μm shown in FIG. 9c;

FIGS. 10a to 10c show the time sequence recordings of the normalized transmission spectrum of a SiO₂ colloidal photonic crystal Fabry-Perot etalon with both colloid coatings fully wetted with ethyl alcohol shown in FIG. 10a, partially wetted due to the evaporation of the ethyl alcohol shown in FIG. 10b, and nearly absent of ethyl alcohol left shown in FIG. 10c;

FIG. 11 shows an example of one embodiment of a colloidal photonic crystal Fabry-Perot etalon for sensing the presence or absence of a media such as a gas, liquid, nanoparticles, bioanalyes, or proteins, etc., in a microchannel embedded with a colloidal photonic crystal; and

FIGS. 12a and b shows one embodiment of a photonic crystal mirror in a microscope image (a) and close-up SEM image (b) where the a silica colloidal photonic crystal of 730-nm microspheres were grown inside a square capillary glass fiber that would form one reflector in a Fabry Perot resonator.

### DETAILED DESCRIPTION OF THE INVENTION

Definitions

As used herein, the phrase “photonic crystal” means a structure periodic in all three dimensions that are designed to affect the propagation of electromagnetic waves in a range of wavelengths, for example, by inhibiting or slowing the propagation of light. For the present definition of photonic crystal, the inhibition of electromagnetic waves must occur in at least one crystal direction, but may also occur in two or three dimensions at similar or different ranges of wavelengths. The material or materials from which the photonic crystal is structured is usually transparent in the spectrum of interest and is typically made from dielectric or metallo-dielectric materials for applications in the ultraviolet, visible, and infrared spectrum.

As used herein, the phrase “stop band” and “photonic band gap” are used here interchangably to represent the range of wavelengths in which the propagation of electromagnetic waves are inhibited.

As used herein, the phrase “Fabry Perot etalon” means a Fabry Perot device in which the separation of two reflecting surfaces are fixed onto a common substrate. This is opposed to a “Fabry Perot” in which the separation distance between the two reflecting mirrors can be freely adjusted.

As used herein, the phrase “Fabry Perot resonator” means all types of Fabry-Perot devices included etalons and resonators with adjustable distance between the two reflecting mirrors.

As used herein, the acronym “PCFP” is a photonic crystal Fabry Perot resonator, in which one or both reflectors comprises of a “photon crystal” with three-dimensional periodic structure as defined above.

A Fabry-Perot cavity comprised of three dimensional photonic crystal mirrors is disclosed. In one embodiment of the invention, the self-assembly of purified and highly monodispersed microspheres are key to creating highly ordered colloidal coatings of high optical quality such that optical devices can function. Such colloidal film mirrors offer high reflection with low losses that are essential for creating Fabry-Perot resonators with good finesse (greater than 7), high resolving power, for example, greater than 1000, or fringes that are spectrally narrower than 1.0 nm. Colloidal films offer the same benefits of high reflection and narrow spectral band responses available from conventional multi-layer dielectric coatings through band gap engineering principles well known to a practitioner of the art. The formation of colloids include silica, latex (polystyrene and polyacrylates), titania, selenium, silver selenide, bismuth, gold, and basically any material that can self assemble. The invention also extends to other means of tailoring the spectrum, for example, through inversion, cladding, sintering, necking, or modification (i.e refractive index trimming) of colloidal crystal templates. The invention also includes Fabry Perot devices comprising of other types of three dimension photonic crystals, or combinations thereof: laser holographic interference, phase mask interference, multi-step lithographic stacking (i.e. Lincoln logs), laser direct-write photopolymerization, etc.

The distinction defining the present embodiment of Fabry-Perot resonator is the fully open structure of the three-dimensional reflection structure, the interstitial spaces, which affords the unique ability for external media to access the critical reflection layers and dramatically alter the Fabry-Perot spectrum, or provide means for crafting novel laser and nonlinear media. This inherent open structure allows the penetration of gas and liquid substances, or entrainment of nano-particles or biological analytes in gases and liquids. The acute optical sensitivity to minute changes within the colloidal structure together with the high spectral resolution afforded by Fabry-Perot devices offer strong spectral responses in reflection and transmission for a wide base of sensor applications or new means of controlling Fabry Perot responses. For example, laser gain media, including novel nano-particle emitters, can be integrated into such porous coatings to create new types of laser resonators and non-linear optical devices.

The invention includes all traditional embodiments of the Fabry-Perot cavities, including etalons, interferometers, waveguide structures, and laser resonators.

The present invention shows that colloidal crystal materials chemistry, as one means of forming three-dimensional photonic crystals, can produce practically efficient and high resolving power Fabry-Perot resonators, having sharp resonance transmission peaks in the stop band. Reduction of microsphere size dispersity and enhancement of colloidal photonic crystal domain size were key to producing this high resolving power optical response. In one embodiment of the invention, fringes of 0.5 nm width were produced at a resolving power of 2400. With further refinement in the quality of colloidal assembly, no restrictions are anticipated on the values of optical resolution and resolving power available from the colloidal photonic crystal Fabry Perot devices in the present invention. With appropriate refinement, these principles for forming high resolving Fabry-Perot devices extend to all methods of fabricating three-dimensional photonic crystals.

The invention includes various means of probing or applying the Fabry-Perot resonator, including: absorption, reflection and/or transmission spectroscopy, fluorescence excitation, nonlinear optical responses, lasing, sensing applications, probing angles from normal incidence (0 degrees) to grazing angles at 90 degrees, including excitation of waveguiding modes between the mirrors, at grazing angles, probing at various states of polarization, including any combination of linear, elliptical, circular, random, etc.)

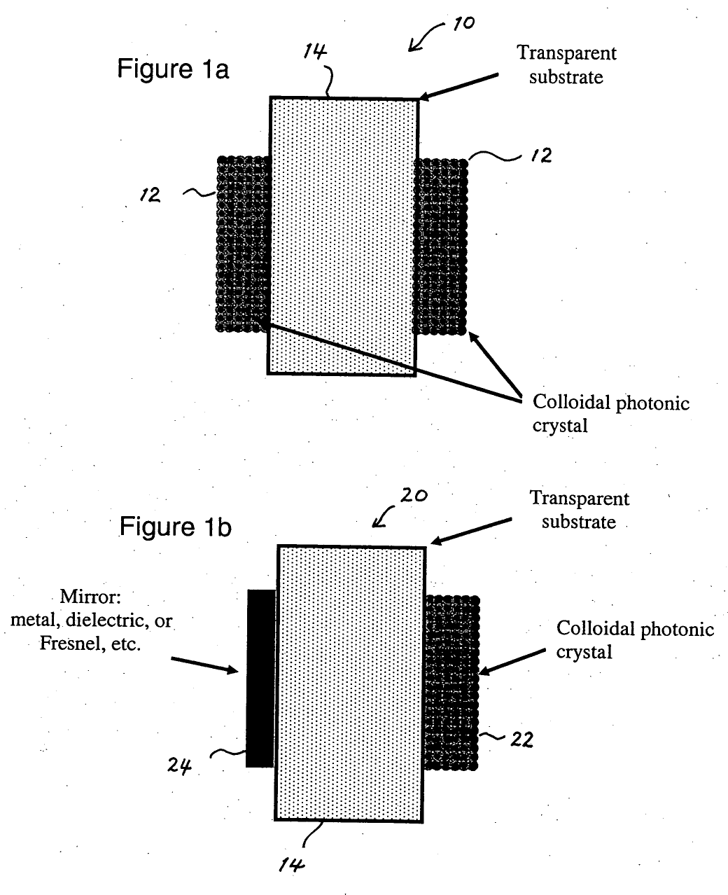

The present invention comprises of one or more photonic crystal films to provide multi-reflection effects. In one embodiment of the invention a Fabry Perot device shown generally at 10 in FIG. 1a includes colloidal photonic crystal photonic films 12 coated on opposing surfaces of a planar transparent substrate 14. The colloidal crystal photonic films 12 may be identical or different in structure or composition or thickness, depending on the application. The coatings 12 may also include other types of photonic crystals having three-dimensional periodic structure. This form of Fabry Perot device is typically known as an etalon because the spacing of the colloidal crystal photonic films 12 is fixed by the thickness of substrate 14. The substrate 14 may also include other types of media such as laser, nonlinear media, photonic crystals, gas, or absorbing media, and consist of several separate substrates that have been bounded together to form a single substrate.

Referring to FIG. 1b another embodiment of the invention, shown generally at 20 is an asymmetric Fabry Perot etalon comprised of a colloidal crystal photonic films crystal film 22 coated on one of the opposed surfaces of the planar transparent substrate 14 while the other surface has a partially or highly reflecting mirror 24 based, for example, on Fresnel reflection or reflection from a metal film, a dielectric stack, or other. The coating 22 may also include other types of photonic crystals having three-dimensional periodic structure.

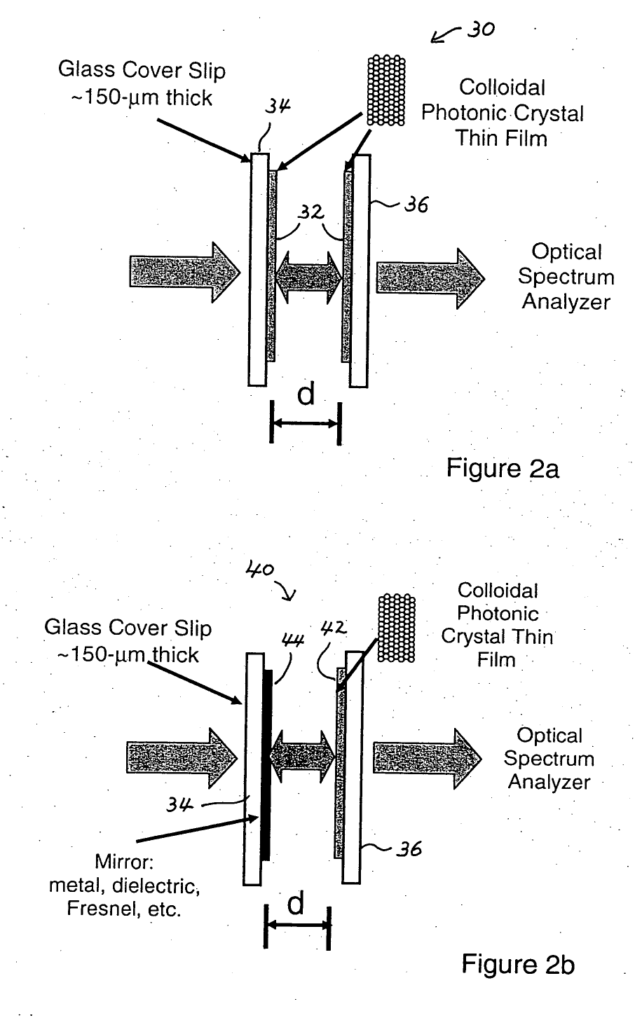

A third embodiment of the invention is shown generally at 30 in FIG. 2a and includes colloidal crystal photonic films 32 present on separate substrates 34 and 36 and aligned to form a parallel Fabry Perot resonator with a tunable separation distance d between the substrates 34 and 36. A multitude of materials may be used for the substrates 34 and 36 and the media between the colloidal films 32. The colloidal crystal photonic films 32 may be identical or different in structure or composition or thickness, depending on the application. The coatings 32 may also include other types of photonic crystals having three-dimensional periodic structure. Also, one or both mirrors may be rotated to move the colloid film to the outside surface(s) of the resonator.

A fourth embodiment of the invention is shown at 40 in FIG. 2b which includes a colloidal crystal photonic film 42 coated on one surface of substrate 36 while the other substrate 34 contains a partial or high reflecting mirror 44 based, for example, on Fresnel reflection or reflection from a metal film, a dielectric stack, or other functional film. The coating 22 may also include other types of photonic crystals having three-dimensional periodic structure.

One non-limiting approach for colloidal crystal film growth is presented but those skilled in the art will understand that this method is exemplary only and appreciate there will be other methods for growing the colloidal crystal films, which are not excluded from the present invention. Monodisperse (polydispersity ≦1.5%) silica microspheres of 640-nm diameter were synthesized from smaller seeds (˜175-nm) following Gieshe's method. [Unger Klaus, Gieshe Herbert, Kiknel Joachim, Spherical SiO₂ particles, U.S. Pat. No. 4,775,520] Microspheres were purified by standard procedures and then self-assembled onto glass surfaces by the method of isothermal heating evaporation induced self-assembly (IHEISA) [S. Wong, V. Kitaev, and G. A. Ozin, J. Amer. Chem. Soc. 125, 15589 (2003)] during which the glass substrate was immersed vertically into microsphere solutions. IHEISA works by keeping microspheres suspended during the vertical deposition in the meniscus with a suitable thermally induced convection field. It has proven to be a rapid and reproducible approach to produce highly ordered, large area, controlled thickness, defect and crack-free silica colloidal crystal film, without any limitations imposed on the microsphere size.

More particularly, the substrate for the deposition was immersed into a container with a silica dispersion in ethanol (volume fraction varied from 2 to 20 vol %), which was heated isothermally in a thermostated chamber at 79.5 C. Upon solvent evaporation, the film is formed within 3-hour time. The method is fast, reproducible and is capable of yielding large centimeter-size areas. The thickness can be easily varied by the silica concentration in the dispersion.

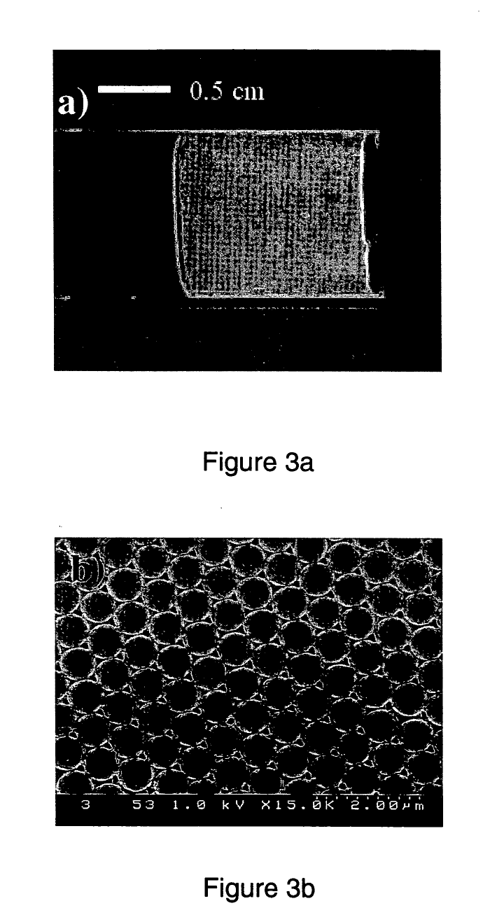

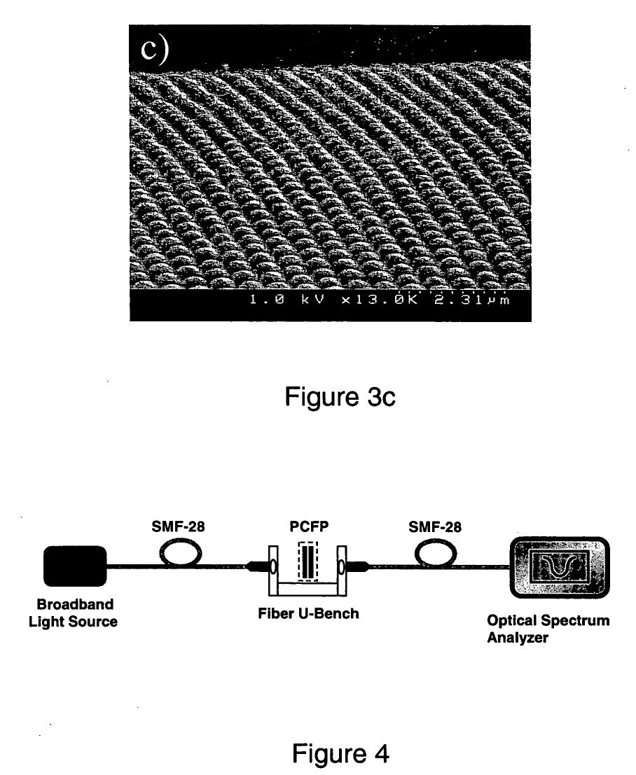

In the method described herein nearly identical silica colloidal photonic crystal thin films with a thickness in the range of 1-2 μm were grown simultaneously on both surfaces of a 148 μm thick glass cover slip (VWR, Scientific), to define a 148 μm-thick Fabry-Perot etalon or resonant cavity. Defined by the cover slip dimensions, arbitrarily large areas of colloidal crystal film can be grown at once on both sides of the cover slip with a typical single crystal domain area of ˜50 μm×50 μm. A photograph of the coated glass slide is shown in FIG. 3a together with a field emission scanning electron microscopy (SEM) (Hitachi S-4500) image (FIG. 3b) that reveals the highly ordered microsphere arrangement of the (111) crystal surface. Colloidal assembly is also possible on curved substrates, attractive for example in countering diffraction losses in high-finesse Fabry Perot applications or focusing through optical systems, including optical fibers. An SEM image of a colloidal crystal assembled over a cylindrical substrate is shown if FIG. 3c.

The three dimensional photonic crystal films may be modified using the processes of inversion, sintering, necking, refractive index variation, laser writing, e-beam modification, ion-beam modification, immersion with polymers, resists, fluidics or gases, the introduction of bio-analytes, nanoparticles, micro-particles, etc. Such modification may be applied to the whole colloidal film, or parts therein to create, for example, defect points, defect lines or defect planes that modify spectral response of the original or modified photonic crystal film. The formation of colloidal films is also not limited to silica microspheres, but extends to other materials such as self-assembly of latex (polystyrene and polyacrylates), titania, selenium, silver selenide, bismuth, gold, and basically any material that can self assemble. Further, three-dimensional photonic band gap structures may be fabricated by other methods not involving self-assembly of colloid films, such as layer-by-layer, Lincoln logs, holographic interference in resist films, phasemask interference in resist films, and laser direct-write photopolymerization, to name only a few.

The photonic crystal coated Fabry-Perot (PCFP) etalon was optically characterized in the spectral vicinity of the photonic band gap centered at ˜1385 nm, as expected for a [111] oriented colloidal photonic crystal consisting of 640 nm silica microspheres. The etalon was mounted into a U-bench (FB221-FC, Thorlabs), and probed at normal incidence with fiber-coupled light from a multi-diode LED source (83427 Å, Agilent). The light was collimated to a 500 μm diameter at the etalon, and the transmitted beam was focused by a second lens into a single-mode optical fiber (SMF-28). A schematic of the arrangement is shown in FIG. 4.

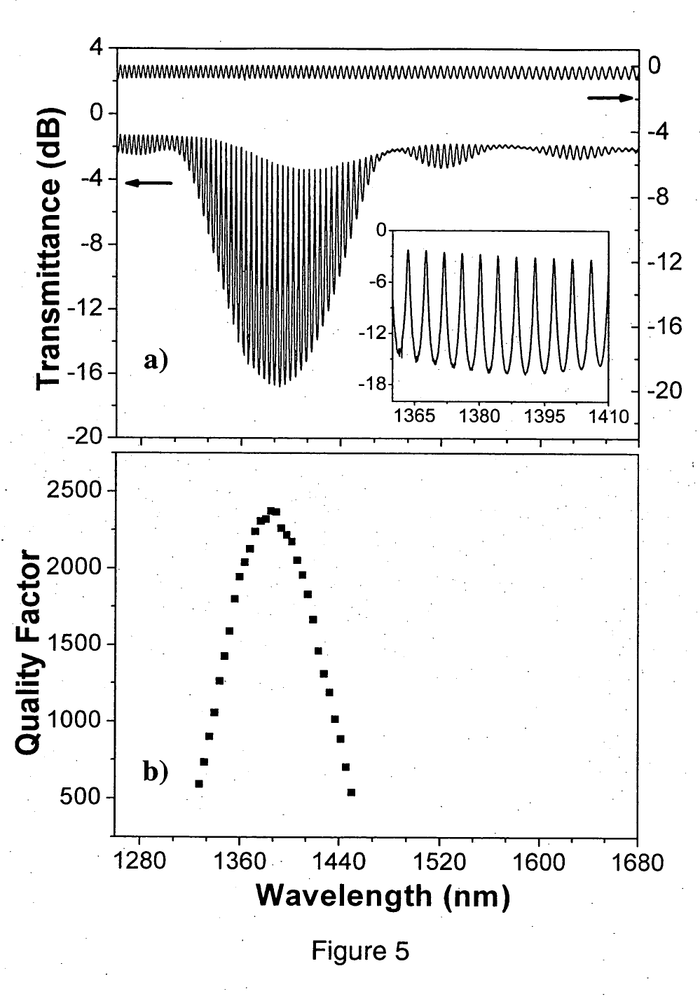

A typical transmission spectrum, recorded by an optical spectrum analyzer (AQ6317B, Ando), is shown in FIG. 5a (bottom spectrum) with an inset depicting part of the signal around the stop band center. The spectrum was normalized to the free space transmission signal without the Fabry-Perot sample present in the U-bench light path. For comparison, FIG. 5a (top spectrum) illustrates the normalized transmission spectrum of the bare glass substrate, which was measured by translating the PCFP sample to an uncoated surface area. The bare-glass transmission follows exactly the classical interference pattern of a plane parallel Fabry-Perot etalon with 148 μm cavity length and ˜4% Fresnel reflectance at air-glass interfaces. The main feature of the transmission spectrum for PCFP is the sharp interference fringes that exist following the spectral profile of the photonic band gap. The lines narrow to ˜0.5 nm at the center of the stop band corresponding to a finesse of approximately 8. The free spectral range of the PCFP is found to be ˜20-GHz narrower than that of the bare-glass Fabry-Perot. This implies that the equivalent cavity length of the PCFP is slightly longer than the glass thickness or the spatial separation of the two colloidal photonic crystal mirrors, which is characteristic of a Fabry-Perot cavity with the distributed feedback of interference based reflection mirrors.

FIG. 5b shows the measured cavity quality factor of the PCFP, which is defined as the center frequency of each transmission peak divided by its full width at half-maximum (3 dB). The amplitude profile of the Q-factor resembles that of the reflection spectrum of the stop band with the maximum located at the band center. This clearly reveals a stop-band-reflection that is dependent on the cavity photon lifetime. The high peak Q-factor of ˜2400 attest to the high reflection and low loss within the present colloidal photonic crystal coatings as well as to the low phase-front distortion that is only possible with highly parallel and ordered monolayers. The reflectance of the single surface colloidal photonic crystal mirror (˜15 silica microsphere layers) at the band center was estimated to be greater than 70% given a 16-dB attenuation in the transmission spectrum.

A very low ˜1.5-dB insertion loss is attributed to the small number of defects in the colloidal photonic crystal coatings as can be also deduced from the high-quality crystal surface shown in FIG. 3b. Discontinuities between single crystal domains within the 500 μm diagnostic light beam are assumed to be the main source of light loss. Such losses are significant in limiting the maximum colloidal film thickness possible before benefits in higher reflectivity (and higher finesse and higher quality factor) are lost to increased optical losses that wash out of the Fabry Perot fringes. Higher finesse and higher cavity quality factor is therefore anticipated with an optimization of the colloidal photonic crystal thickness that trades losses in thicker films against higher reflection in thicker films.

The measured quality factor value shown in FIG. 5b also includes diagnostic limitations of a U-bench designed for collimation at 1550-nm wavelength in a ˜40-nm bandwidth. The present colloidal crystal film with 1400-nm band gap undergoes additional Fabry-Perot losses due to a slightly divergent beam in the U-bench. Higher values of finesse and Q-factor are therefore anticipated for a U-bench optimized for the present 1400-nm wavelength, or alternatively, for silica microspheres with ˜730-nm diameter that shifts the band gap to 1550 nm.

To confirm that the PCFP fringes in the observed transmission spectrum of FIG. 5a are indeed due to interference between the two separated colloidal films, a one-dimensional transfer matrix method as typically adopted for modeling multi-beam optical interferences in single or multi-layer systems was applied to the two colloidal films. In the simulation, the PCFP was approximated as a thin glass substrate coated on both surfaces with periodic multi-layered films of period set to the distance observed between the crystal planes along the [111] direction. The refractive index representing the glass balls layers was set to a weighted average index profile following a cosine profile in a direction normal to the surface. This profile approximately represented the axial distribution of the areal density of the silica microspheres with minimum and peak refractive index values of 1 for air and 1.45 for the silica, respectively. The model provided an average refractive index value of 1.33 to match that expected in the three-dimensional silica colloidal photonic crystals. SEM images similar to FIG. 3b were used to estimate the sphere diameter and lattice parameter of the films used in the spectral recordings.

With the substrate thickness fixed to the measured 148-nm value, an expected refractive index value of 1.49 was obtained by matching the free spectral range (˜4.5-nm) observed in the bare glass substrate in FIG. 5a (top spectrum). The number of microsphere layers was not an adjustable parameter and was set to 15 layers as observed from an SEM image of the film cross section. The transmission loss of the colloidal photonic crystal layers was an adjustable parameter in the model yielding a best match to the observed spectrum for imaginary refractive index value of κ=0.0017. This value yielded a 1.2-dB insertion loss, closely matching the 1.5-dB observation in FIG. 5a.

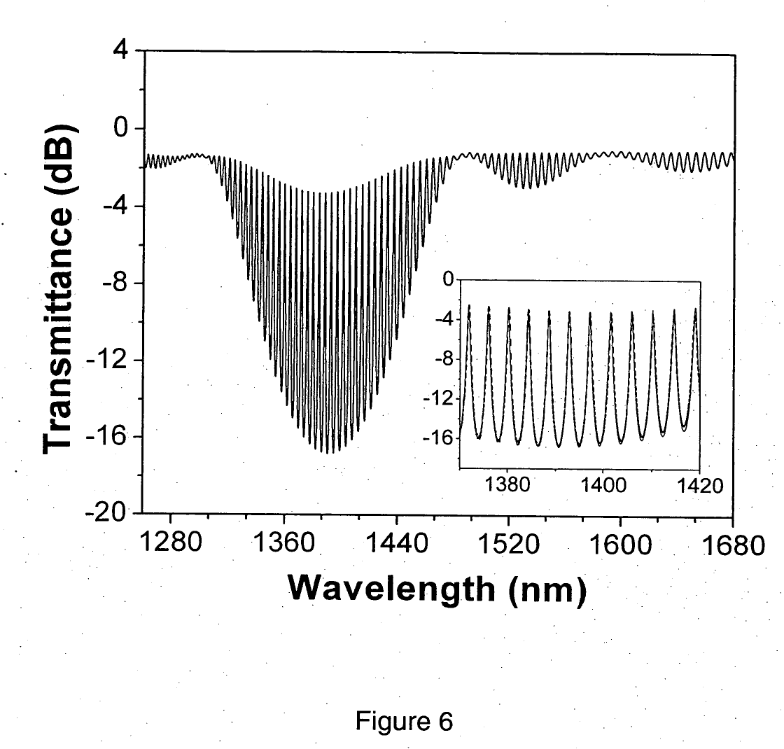

The PCFP simulation result is plotted in FIG. 6 with an inset showing both the simulated and measured (dashed line) spectra around the stop band center. It can be clearly seen that the simulation very closely reproduces the main features of the observation in FIG. 5a, following the stop-band resonance, fringe resolution and side lobe interference structures. This simple 1-D model provides the convincing proof that high resolution Fabry-Perot fringes, are indeed being created by the two three-dimensional colloidal-photonic-crystal film layers in the etalon embodiment shown schematically in FIG. 1a. Colloidal photonic crystal mirrors are therefore demonstrated for the first time to yield low losses, high quality-factor, and high resolving-power in a fixed length Fabry-Perot resonant cavity (i.e. etalon).

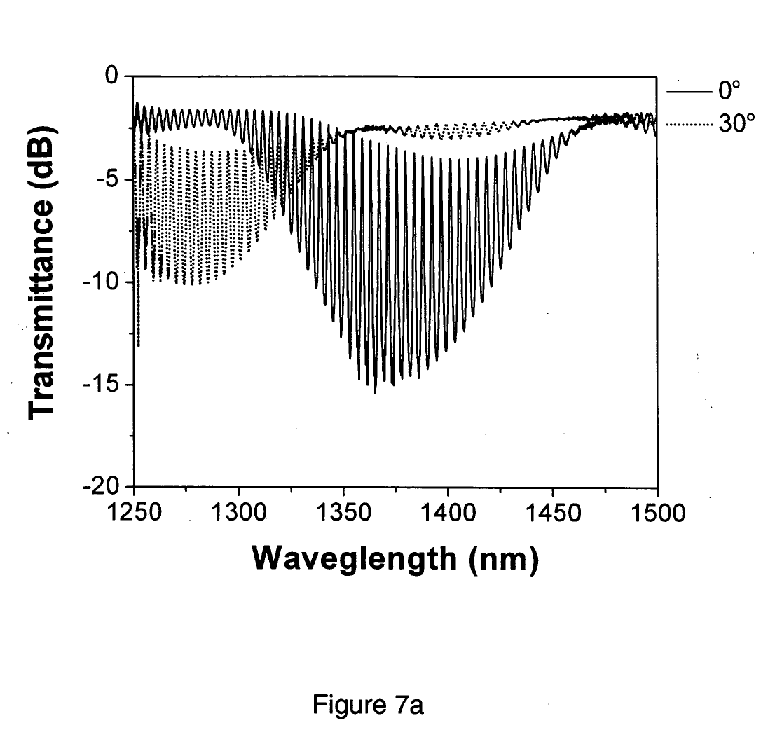

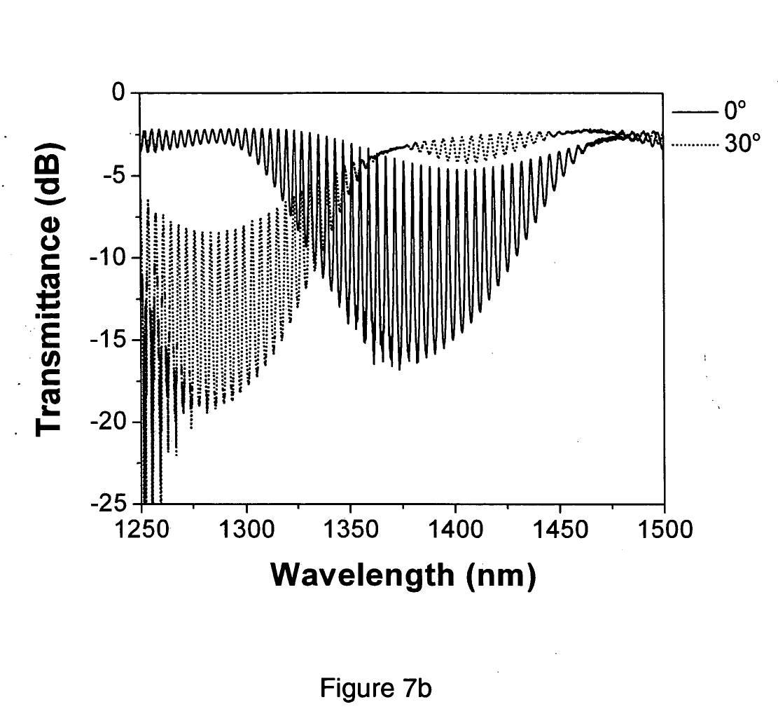

Like conventional etalons or Fabry-Perot resonators, the PCFP can be probed at angles not normal to the surface, thereby spectrally shifting the fringes and inducing polarization sensitivity. However, the PCFP can provide high angular sensitivity due to strong birefringence and large band gap shifts that are intrinsic to the unique crystal symmetry underlying the structure of the photonic crystal. FIG. 7 shows the normalized transmission spectra of a SiO₂ colloidal photonic crystal Fabry-Perot etalon for TM (a) and TE (b) mode, probed at 0 degrees and 30 degrees incident angle with respect to the surface normal. For both TM and TE modes, the stop band carrying the Fabry-Perot fringes shifted to shorter wavelength by ˜100 nm as the probe angle increased from 0° and 30°. Such spectral shifts of the Fabry-Perot fringes can be finely tuned by adjusting the relative angle between the Fabry-Perot resonator and the probing light beam. Controlling the relative angle is attractive for tuning a PCFP sensor to probe for a specific wavelength response, for example, from a targeted analyte that is present inside the photonic crystal structure. Alternatively, angles can be tuned to reject spectral bands that contribute unwanted signal or ‘noise’ to a desired probing signal. In a different embodiment, various light sources can be launched at a multitude of angles to probe the same photonic crystal volume and extract multiple spectral readings tuned to detect various physical quantities or analytes, for example.

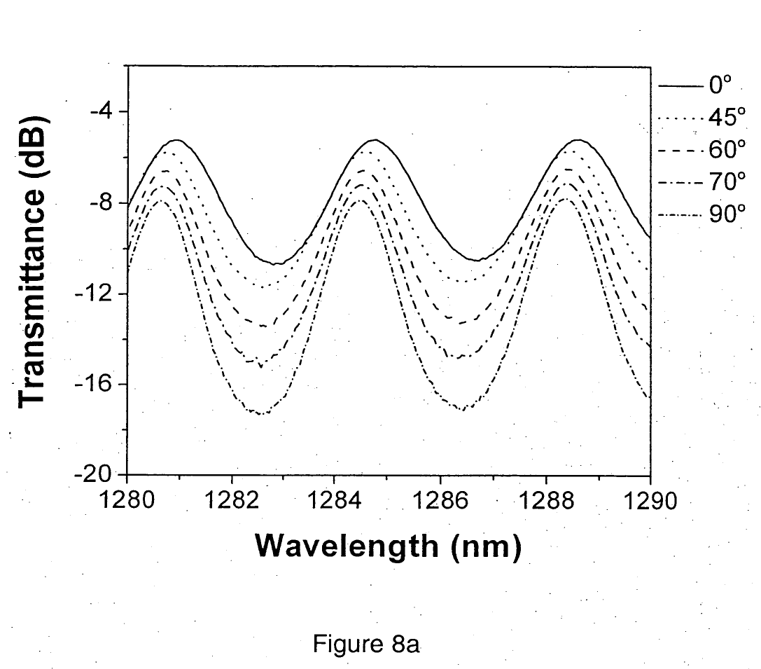

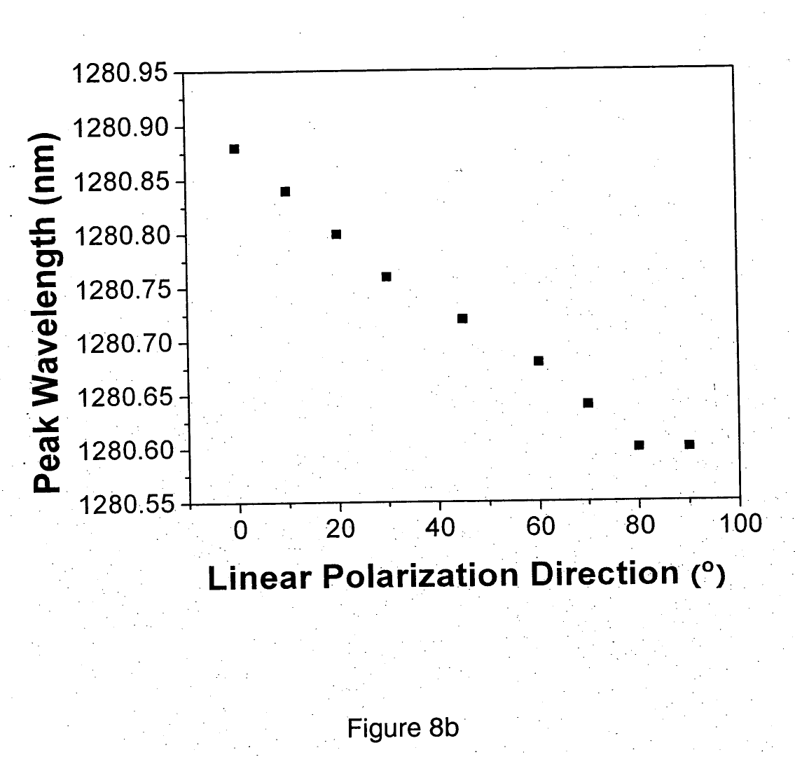

The polarization of incident radiation presents another means of controlling the spectral observation of PCFP devices that is not clearly apparent in FIGS. 7a and 7b. Careful analysis of the data in FIGS. 7a and b reveals strong birefringent affects that spectrally shift the fringes and modify the overall transmittance in the stop-band as the laser polarization is rotated from TM to TE. FIG. 8a shows an expanded view of the normalized transmission spectrum recorded in the centre of the stop band (i.e. from FIGS. 7a and 7b) for 30 degree incident angle (30°). The five different spectra were recorded for linear laser polarization rotating sequentially from TM (0°) to TE (90°). Lower fringe contrast for TM polarization suggests lower reflection and lower Fabry-Perot finesse than for TE polarization. FIG. 8b follows the resonance wavelength of a single Fabry-Perot fringe (i.e. the same interference order) near the peak of the stop band as a function of the linear polarization orientation. The moderately high resolving power of the PCFP is sufficiently sensitive here to follow with fine precision the incremental changes in the overall 0.3 nm spectral fringe shift that arises from the birefringence in the colloidal films mirrors. The linear response of wavelength shift with polarization angle changing from TM (0°) to TE (90°) adds polarization sensitive spectral detection as an additional detection mode of the present invention.

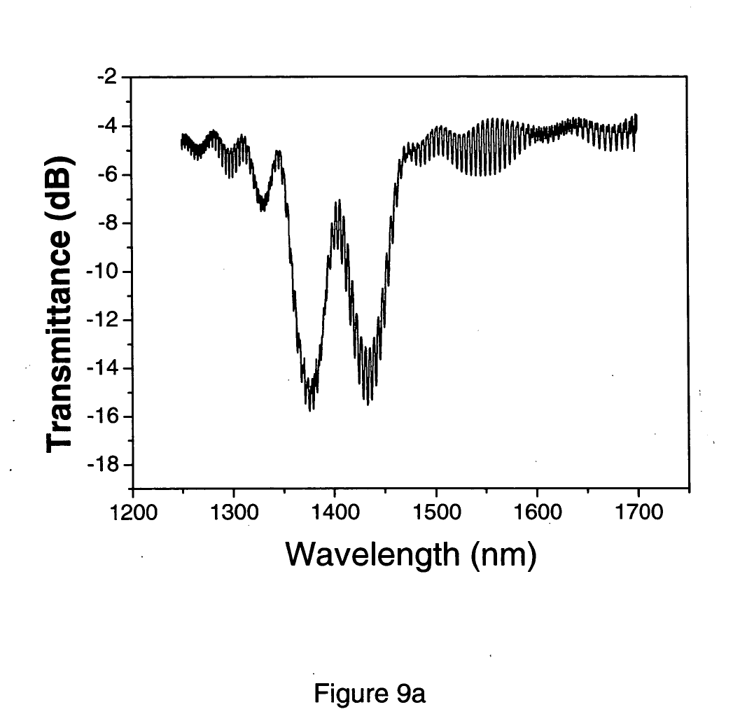

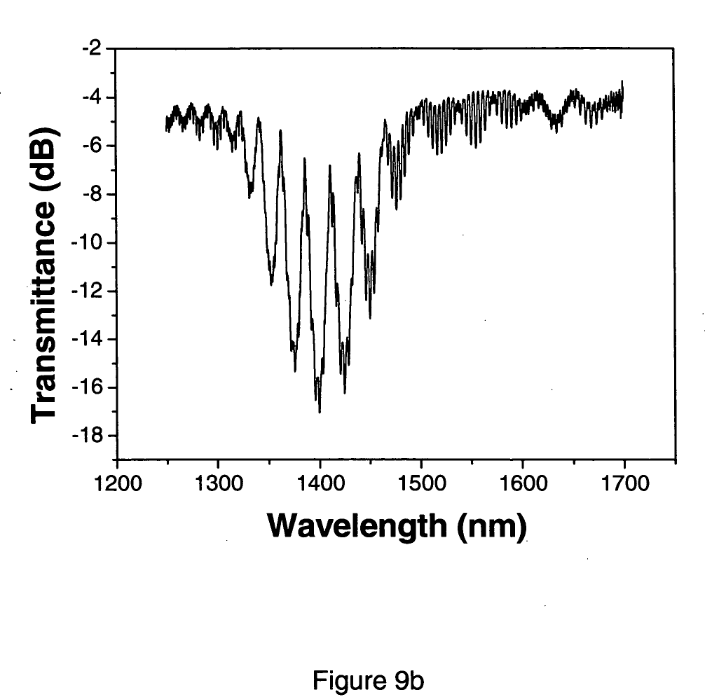

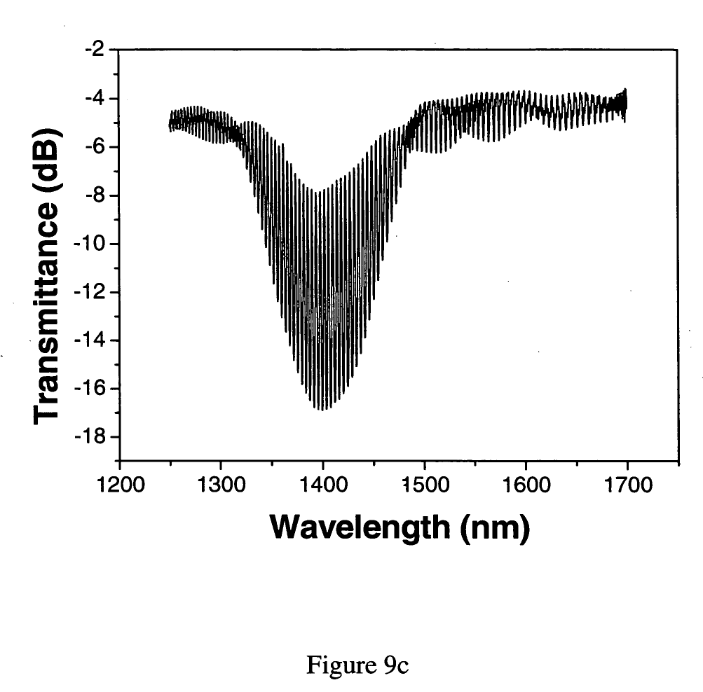

FIG. 9a, b, c shows the transmission spectra based on another embodiment of the PCFP shown schematically in FIG. 2a. Colloidal crystal films of identical thickness and microsphere diameter were grown on separate substrates. Only one surface was coated on each substrate. The substrates were then aligned in parallel with precision micro-stages and probed optical in the photonic band gap region using the U-bench configuration of FIG. 4. The mirror separation, d, was varied over a large range of several microns to several hundred microns, with examples of d=˜14 μm, ˜35 μm and ˜200 μm corresponding to the spectra observations in FIGS. 9a, 9b, and 9c, respectively. The large mirror separation in FIG. 9c provides high contrast fringes similar to that seen in the etalon case of FIG. 5a. However, variable mirror separation such as embodied in FIGS. 2a and 2b offers significant flexibility for tuning the free spectral range and the resolving power of the PCFP to meet highly varied applications in comparison with a single Fabry Perot Resonator as embodied in FIGS. 1a and 1b. This flexible tuning distance extends to very small separations approaching a fraction of an optical wavelength (approximately 0.2 microns) where only one fringe becomes visible in the stop band, and can be flexibly positioned according to the separation distance. While such ‘defect’ features have been demonstrated in prior art based on inserting permanent defects within a fixed photonic crystal structure,¹⁷ the present invention encompasses PCFP devices also having a single ‘defect’ line, but tunable by any means of adjusting the optical cavity length (i.e. physical length, electro-optically, pressure, temperature, flow of different material through open porous structure of photonic crystal, etc.)

Tuning the mirror separation, d, demonstrates the expected decrease in free spectral range according to Δλ_{fsr}=λ²/2d for an air gap, and provides a convenient means for the precisely controlling the PCFP spectrum. Here, λ is the wavelength. FIG. 9a shows a large free spectral range of >60-nm with a strong single defect line centered in the photonic band gap. The finely spaced fringes (Δλ_{fsr}=˜4 nm) with weak modulation amplitude seen here is due to etalon effects in the two glass substrates supporting the colloidal film and can serve as a calibration marker or can be eliminated by anti-reflection coatings on the colloid-free surface.

A mirror separation of 35-μm introduces approximately six Fabry Perot interference orders in the transmission spectrum stop band as seen in FIG. 9b. The free spectral range is ˜25-nm and the associated modulation continues out side the stop band for this case. FIG. 9c shows several dozen high transmittance fringes in the photonic band gap for a mirror separation of ˜200-μm and a free spectral range of ˜4-nm. At such large mirror separation, the fringe spacing decreases below the resolving power of the present optical spectrum analyzer. However, higher resolving power is anticipated for larger mirror separation but could not be tested with the present diagnostic equipment.

The microsphere self-assembly method is potentially a low cost fabrication method for creating a multitude of Fabry-Perot devices, with planar or curved mirrors, with identical or dissimilar coatings (i.e. FIG. 1a versus 1b or FIG. 2a versus 2b). Spectral coverage to the visible and other infrared spectral regions is scaled by means familiar to practitioners skilled in the art of colloidal self-assembly or other fabrication methods of other three-dimensional photonic crystals. The photonic band gap for colloidal films is determined foremost by the microsphere diameter selected during colloidal photonic crystal self-assembly. In other methods, the photonic band gap is determined foremost by the modulation period used to structure the material. The range of applications extends from 10 cm in the microwave spectrum, to 30 nm in the extreme ultraviolet spectrum. Further fine tuning of the spectral response can be realized by post-trimming the filling fractions of the colloidal crystals or other three-dimensional photonic crystals with chemical or thermal sintering processes, refractive index changes, or inversion of the matrix with other materials such as demonstrated with silicon, for example. It is also possible to do the fine tuning by laser writing, e-beam modification, ion-beam modification, immersion with polymers, resists, fluids or gases, the introduction of bio-analytes, nanoparticles, micro-particles, etc. The refractive index contrast is an important determination of the reflection of the colloidal crystal film, and also provides means for creating an omnidirectional photonic band gap. However, a photonic band gap is not necessarily required in all directions.

The formation of colloidal films is also not limited to silica microspheres, but extends to all materials that can self-assemble into three-dimensional photonic crystals, including but not limited to latex (polystyrene and polyacrylates), titania, selenium, silver selenide, bismuth, and gold. The invention also includes the use of three-dimensional photonic crystal films made by other methods such as Lincoln logs, holographic interference in resist films, phasemask interference in resist films, and laser direct-write photopolymerization, etc., to create one or two mirrors that comprise the present invention of a photonic crystal Fabry-Perot or etalon resonator.

One non limiting example of modifying a three dimensional photonic crystal is to infiltrate interstitial spaces of the crystal mirror with materials which, in the presence of specific analytes, experience refractive index changes. Hydrogel is one kind of such materials that swells and shrinks reversibly with the existence of certain analytes. In one embodiment of the present invention, the hydrogel-impregnated colloidal crystal serves as one mirror in a high resolving power PCFP that yields sharply resolved Fabry Perot fringes that greatly enhance the detection limits for recognizing specific analytes as they modify the refractive index in the photonic crystal.

The present invention includes colloidal crystal assemblies and other three-dimensional photonic crystals that also employ graded refractive index profiles for spectral shaping or apodization purposes. Assembly of uniaxial or biaxial colloidal films or addition of symmetry breaking process, provide polarization effects for additional applications such as wave plate retarders or beam combiners. Angle tuning of the PCFP opens several more application directions as noted in FIG. 9, but also including waveguiding structures when light becomes trapped between the colloidal crystal films by either band gap reflection or total internal reflection.

The optical engineering of Fabry-Perot resonators comprising of photonic crystal film or films provides a multitude of optical design options that can be flexibly tuned to meet numerous applications. To practitioners experienced in the art of fabricating three-dimensional photonic crystals, the film properties can widely varied to control the overall response of the Fabry-Perot device including the central position, spectral bandwidth, and spectral shape of the stop band, the peak reflectance, transmission, and loss in the stop band, the angle and polarization dependence, the free spectral range, and the resolving power. These factors can be controlled, for example, by increasing the film thickness (i.e. number of periodic layers), increasing the contrast in the refractive index modulation, increasing the average refractive index, and improving the periodicity and surface roughness of the structured films. Thicker photonic crystal films will exhibit increased reflection which will have several desirable implications, including sharper fringes (higher finesse, higher resolution). But, thicker films can also lead to increased losses (due to scattering and unintentional defects in film) that reduce performance. Thus, thickness is a trade off of providing higher finesse against optical losses that reduce the visibility of the fringes. For practical purposes of the present invention, the number of periodic layers in the photonic crystal film can vary from one layer to 400 layers. Further, it is possible to produce a desired contrast in refractive index by exchanging materials (i.e. by inversion) so that, for example, a higher contrast will yield an increase in film reflection or permit the use of thinner films that provide a similar reflectance to the original material.

The central innovation is to combine a three-dimesional photonic crystal with another similar or dissimilar photonic crystal or mirror to define a Fabry Perot resonator. When two photonic crystal mirrors are employed (i.e FIG. 1a or 2a), the films can be of different types such that the stop bands do not necessarily overlap. A small but non-zero reflection, for example by Fresnel, from one of the photonic crystal films can provide sufficient feedback to create Fabry-Perot fringes within the stop band of opposite photonic crystal film mirror, or vica versa, to yield a working device under the present invention. Alternatively, in a sensing application, the photonic crystal band gap in the “sensing” mirror can be shifted by an external stimulus (i.e injection of liguid, gas, analyte into open porous structure) such that the bandgap shifts to partially or wholly overlap the stop band of the opposing photonic crystal and thereby create Fabry-Perot fringes within the overlapping band gap spectrum. In another modification, the partial overlap of stop bands by two different photonic crystal films may provide at least one detectible fringe to constitute a device in the present invention.

Other factors controlling the performance of a photonic crystal Fabry-Perot resonator are common to traditional Fabry Perot devices and well known to practitioners skilled in the art of Fabry Perot resonators. For example, an increase in the separation distance of the two reflecting mirrors, either by physical moving two separate substrates, or by increasing the substrate thickness in the case of an etalon, will reduce the free spectral range and improve the resolving power (i.e spectrally narrower fringes) of the Fabry Perot. However, large separation distances can make the instrument more difficult to align and reduce visibility of fringes at some point when diffraction effects are not compensated, or when the optical quality of the film is not adequate to maintain the beam quality in the resonator.

The present invention opens a multitude of applications due to the periodic macroporous open structure of the colloidal photonic crystal coated mirrors. These colloidal photonic crystal coatings are therefore highly sensitive to ambient media changes, including gas, liquid, solid, or plasma phases. Similar sensor benefits have been described for holey fibers. [Sabert, Hendrik et al., Fluid analysis using photonic crystal waveguide, WO 2004001465] Because of the large surface area in the colloidal crystal mirror, large spectral responses are expected when biological or chemically active surface coatings are applied to the colloidal assembly to target specific molecules, analytes, proteins, etc. Etalon, tunable Fabry-Perot interferometers, laser resonators, optical waveguides, constitute several of the embodiments claimed.

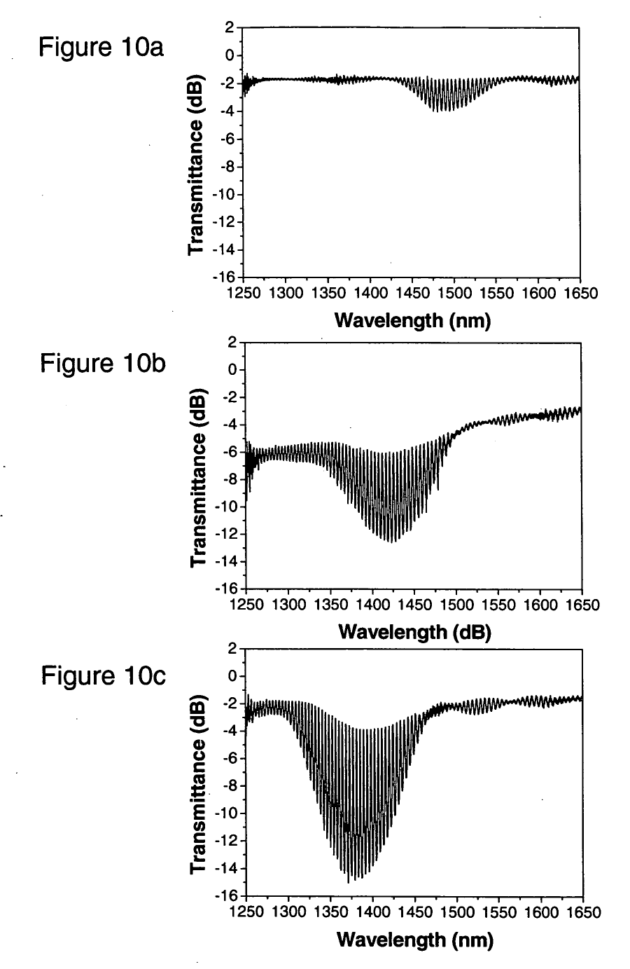

As a non-limiting example of a sensor application, FIG. 10 shows the dramatic spectral shift in PCFP spectral response when ethyl alcohol was applied to both surfaces of a photonic crystal etalon. The PCFP used here had the embodiment as shown in FIG. 1a and yielded the spectral response shown in FIG. 5a in the presence of air. FIG. 10a shows the transmission spectrum when both the photonic crystal mirrors were completely wetted with ethyl alcohol. Evaporation of ethyl alcohol leads to partial filled photonic crystal mirrors that lower the average refractive index while increasing the index contrast as air displaces the alcohol. The blue spectral shift and strong fringe contrasts seen in the representative transmission signal shown in FIG. 10b are commensurate with these physical changes. In several minutes, the alcohol is fully evaporated and the spectrum recovers to the original spectrum as shown in FIG. 10c. Similar dramatic spectral changes are noted for several solvents and also when only one mirror is soaked with the alcohol. By sensing small spectral shifts, a multitude of PCFP configurations provide high sensitivity for identifying solvents or mixtures of solvents, recording physical changes like temperature or pressure, recognizing changes in gaseous media, or moleculues, or bioanalytes, of nanoparticles, etc. that are entrapped or flowing through the open structured photonic crystal film.

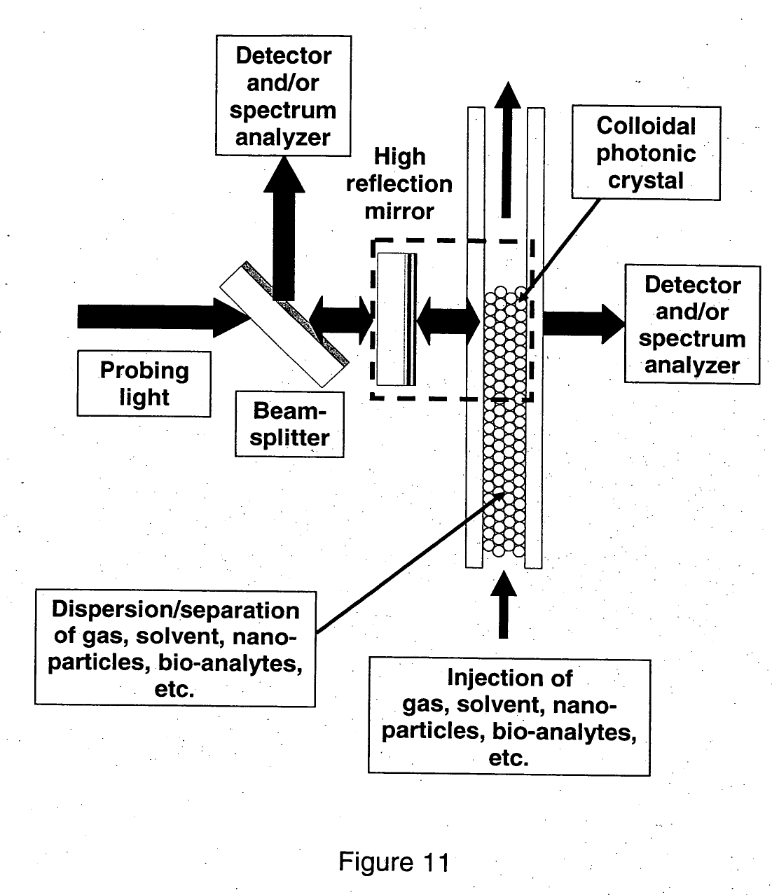

Another example embodiment of this invention is illustrated in FIG. 11, where a colloidal photonic crystal is coated on the inner surface or fills the volume of a micro-vial or capillary channel and comprises a Fabry-Perot cavity when a second mirror is aligned to form a Fabry Perot or etalon resonator. This second mirror may be coated directly onto the micro-capillary structure to form, for example, a symmetric or asymmetric etalon analogous to the embodiments in FIGS. 1a and 1b. Alternatively, the second mirror may be located on a separate substrate and aligned independently in an embodiment similar but not limited to that in FIGS. 2a and 2b. As a non-limiting example, FIG. 11 demonstrates the application of an asymmetric PCFP as embodied in FIG. 2b.

The micro-vial or capillary such as shown in FIG. 11 may be employed for guiding the flow of a gas or liquid agent to be analyzed and has advantages such as sensing small sample volumes or low concentration agents while enabling convenient integration with other microfluidic systems. The photonic band gap enables real-time in-situ diagnostics of materials such as gases, solvents, nanoparticates, quantum dots, proteins, bio-analytes, etc. as their varying concentration within the porous photonic crystal alters the spectral response as observed and probed directly by Fabry-Perot interferometry. In addition, the porous photonic crystal also introduces highly dispersive fluidic mechanics under pressure, electro-osmotic or electrophoretic forces, as non limiting examples, that act much like chromatographic columns to facilitate rapid and efficient separation of solvents, gases, or nano-particles, cellular proteins and bioanalytes, etc., with critical dimensions of ˜10 nm. Further, the large surface area of photonic crystal together with modifications to functionalize surfaces of the photonic crystal provides improved separation efficiency. The present invention of PCFP is defined within the dashed lines of FIG. 11, and extends to such capillary filled photonic crystals for purposes of, but not limited to, monitoring or sensing the capillary contents in real time.

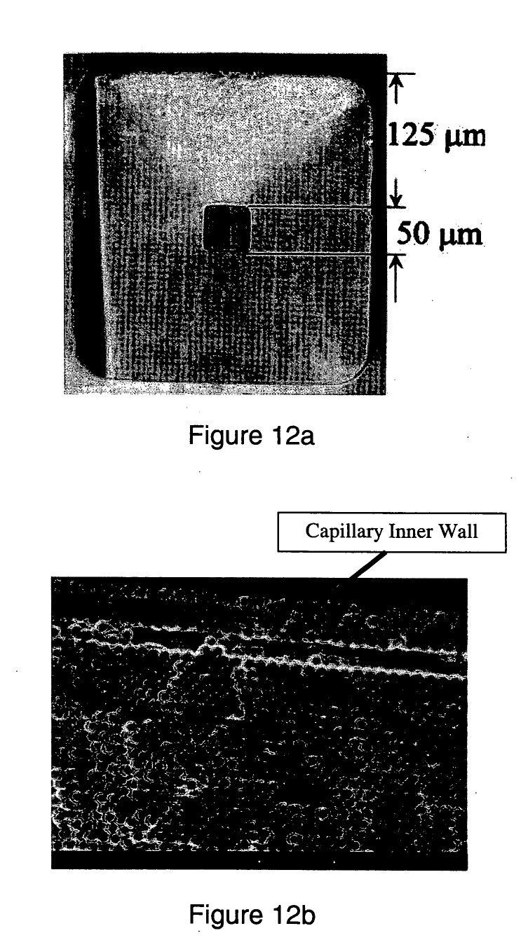

FIGS. 12a and 12b show examples of a glass microcapillary that has been filled with a silica colloid. The square cross-section of the capillary seen in the optical view of FIG. 12a provides a multitude of geometries for defining Fabry Perot or etalon resonators where one of the mirrors are defined by reflections from a photonic crystal embedded in the capillary. FIG. 12b shows an SEM view of silica microspheres self-aligned in the channel. Other geometries include but are not limited to rectangles, circles, polygons, or holey fibers.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes”, and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

1. A device for multireflection of electromagnetic waves comprising,
a substantially transparent substrate having first and second opposed planar or curved surfaces spaced by a pre-selected thickness;
a first three dimensional photonic crystal film deposited on said first opposed surface having a first stop band in a first spectral region, and a second three dimensional photonic crystal film deposited on said second opposed surface having a second stop band in a second spectral region; and
wherein illuminating said device with a light beam of pre-selected wavelength results in interference fringes located within at least one of the first and second stop bands.

2. The device according to claim 1 wherein said first and second stop bands are in first and second spectral regions respectively that partially overlap.

3. The device according to claim 1 wherein said first and second stop bands are in first and second spectral region respectively that are not overlapping, but where the first photonic crystal film provides non-zero reflectance that is inside the second spectral region.

4. The device according to claim 1 wherein the first and second three dimensional photonic crystal films are comprised of one of monodisperse spheres.

5. The device according to claim 1 wherein the first and second three dimensional photonic crystal films have the same thickness.

6. The device according to claim 1 wherein the first and second three dimensional photonic crystal films have a different thickness.

7. The device according to claim 1 wherein the thicknesses of the first and second films of the three dimensional photonic crystals are in a range from about 100 nm to about 100 mm.

8. The device according to claim 1 wherein the substrate has a thickness in a range from about 200 nm to about 5 m.

9. The device according to claim 1 wherein the first and second three dimensional photonic crystal films have an open porous structure thereby allowing flow of a gas or fluid therethrough.

10. A device for multireflection of electromagnetic waves comprising,
a substantially transparent substrate having first and second opposed planar or curved surfaces spaced by a pre-selected thickness;
a three dimensional photonic crystal film deposited on said first opposed surface having a stop band in a pre-selected spectral region, and a reflective coating deposited on said second opposed surface; and
wherein illuminating said device with a light beam of pre-selected wavelength results in interference fringes located within the stop band of the three dimensional photonic crystal film on first opposed surface.

11. The device according to claim 10 wherein the three dimensional photonic crystal film is comprised of one of monodisperse spheres.

12. The device according to claim 10 wherein the three dimensional photonic crystal film has a thickness in a range from about 100 nm to about 100 mm.

13. The device according to claim 10 wherein the substrate has a thickness in a range from about 1 μm to about 5 m.

14. The device according to claim 10 wherein the three dimensional photonic crystal film has a periodic macroporous open structure thereby allowing flow of a gas or fluid therethrough.

15. A device for multireflection of electromagnetic waves comprising,
a first substantially transparent substrate having a first planar or curved surface;
a second substantially transparent or opaque substrate having a second planar or curved surface substantially “parallel” to, and separated from said first surface a pre-selected distance to support an optical resonator;
a first three dimensional photonic crystal film deposited on said first surface having a first stop band in a first spectral region, and a second three dimensional photonic crystal film deposited on said second surface having a second stop band in a second spectral region;
wherein illuminating said device with a light beam of pre-selected wavelength results in interference fringes located within at least one of the first and second stop bands.

16. The device according to claim 15 including adjustment means for adjusting the spacing between the first and second substrates.

17. The device according to claim 15 including a fluid, solid, laser active material, gas, or plasma, located between the first and second substrates.

18. The device according to claim 15 wherein the first and second substrates have a thickness in a range from about 200 nm to about 5 m.

19. The device according to claim 15 wherein the thickness of the first and second films of the three dimensional photonic crystals are in a range from about 100 nm to about 100 mm.

20. The device according to claim 15 wherein the separation of the two substrates are in the range from about 200 nm to 10 km.

21. The device according to claim 15 wherein said first and second spectral regions partially overlap.

22. The device according to claim 15 wherein said first and second spectral regions substantially overlap.

23. The device according to claim 15 wherein said first and second spectral regions are not overlapping, but where the first photonic crystal film provides non-zero reflectance that is inside the second spectral region.

24. The device according to claim 15 wherein the first and second three dimensional photonic crystal films have a periodic macroporous open structure thereby allowing flow of a gas or fluid therethrough.

25. A device for multireflection of electromagnetic waves comprising,
a first substantially transparent substrate having a first planar or curved surface;
a second substantially transparent or opaque substrate having a second planar or curved surface substantially “parallel” to, and separated from said first surface a pre-selected distance to support an optical resonator;
a three dimensional photonic crystal film deposited on said first surface having a stop band in a spectral region, and a reflective coating deposited on said second opposed surface; and
wherein illuminating said device with a light beam of pre-selected wavelength results in interference fringes located within the stop band.

26. The device according to claim 25 including adjustment means for adjusting the spacing between the first and second substrates.

27. The device according to claim 25 including a fluid, solid, laser active material, gas, or plasma, located between the first and second substrates.

28. The device according to claim 25 wherein the first and second substrates have a thickness in a range from about 200 nm to about 5 m.

29. The device according to claim 25 wherein the thickness of the three dimensional photonic crystals are in a range from about 100 nm to about 100 mm.

30. The device according to claim 25 wherein the separation of the two substrates are in the range from about 200 nm to 10 km.

31. The device according to claim 15 wherein the first and second three dimensional photonic crystal films have a periodic macroporous open structure thereby allowing flow of a gas or fluid therethrough.

32. The device according to claim 1 wherein the colloidal photonic crystal are one of a biaxial and uniaxial material.

33. The device according to claim 10 wherein the photonic crystal film is one of a biaxial and uniaxial material.

34. The device according to claim 15 wherein the colloidal photonic crystal films are one of a biaxial and uniaxial material.

35. The device according to claim 25 wherein the colloidal photonic crystal film one of a biaxial and uniaxial material.

36. A method of producing multiple reflections in a photonic bandgap of a three dimensional photonic crystal film, comprising
directing a beam of light of pre-selected wavelength into a structure comprising a substantially transparent substrate having first and second opposed planar surfaces spaced by a pre-selected thickness, a first three dimensional photonic crystal film deposited on said first opposed surface having a first stop band in a pre-selected spectral region, and a second three dimensional photonic crystal film deposited on said second opposed surface having a second stop band in a pre-selected spectral region.

37. A method of producing multiple reflections in a photonic bandgap of a three dimensional photonic crystal film, comprising
directing a beam of light of wavelength in a pre-selected range of wavelengths into a structure comprising a substantially transparent substrate having first and second opposed planar surfaces spaced by a pre-selected thickness, a three dimensional photonic crystal film deposited on said first opposed surface having a stop band in a pre-selected spectral region, and a reflective coating deposited on said second opposed surface having said stop band.
